(19) United States
(12) Patent Application Publication
(10) Pub. No.: US 2009/0119595 A1
(43) Pub. Date: May 7, 2009

(54) Method And System For Presenting A Transition Effect Between Remotely-Sourced Content In A Browser

(76) Inventors: Robert P. Morris, Raleigh, NC (US); David B. Lection, Raleigh, NC (US)

Correspondence Address: SCENERA RESEARCH, LLC, 111 CORNING RD., SUITE 220, CARY, NC, 27518, US

(21) Appl. No.: 11/935,428

(22) Filed: Nov. 6, 2007

(51) Int. Cl. G06F 3/01

(52) U.S. Cl. 715/730

(57) ABSTRACT

Methods and systems are described for presenting a transition effect between remotely-sourced content in a browser. One method includes receiving an association between a transition effect and a condition for applying the transition effect when transitioning between presenting remotely-sourced content in a widget of a browser, and storing separately from the remotely-sourced content the association between the transition effect and the condition. While a first remotely-sourced content received from a first content provider via a network is presented in the widget, an indication to receive, via the network, a second remotely-sourced content from a second content provider for presenting in the widget is received. In response to receiving the indication, it is determined whether the condition is satisfied. The method includes applying the transition effect associated with the condition to at least one of the first remotely-sourced content and the second remotely-sourced content when the condition is satisfied to create a transition that is presentable in the widget.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

As the World Wide Web evolves from two dimensional static web pages to dynamic and interactive videos and three dimensional virtual communities, the manner in which web browsers retrieve and present web oriented content is surprisingly primitive. For example, when a user is viewing a web page presented on a device and submits a request for another web page, the user is typically subjected to page transitions in the form of interstitial popup windows, or popover windows within the current page. These are disruptive, annoying and visually unappealing.

In addition, depending on the presenting device's network connection, the amount of time required to download the content can be significant. During this waiting time, the user is typically presented with a partially loaded web page or a spinning icon and some indication that the page is loading. In the meantime, the user can become bored and impatient, and may eventually lose interest in the page altogether.

Accordingly, there exists a need for methods, systems, and computer program products for enabling a browser to provide a transition between remotely-sourced content, such as web pages, in a browser.

### SUMMARY

Methods and systems are described for presenting a transition effect between remotely-sourced content in a browser. One method includes receiving an association between a transition effect and a condition for applying the transition effect when transitioning between presenting remotely-sourced content in a widget of a browser, and storing separately from the remotely-sourced content the association between the transition effect and the condition. While a first remotely-sourced content received from a first content provider via a network is presented in the widget, an indication to receive, via the network, a second remotely-sourced content from a second content provider for presenting in the widget is received. In response to receiving the indication, it is determined whether the condition is satisfied. The method includes applying the transition effect associated with the condition to at least one of the first remotely-sourced content and the second remotely-sourced content when the condition is satisfied to create a transition that is presentable in the widget.

In another aspect of the subject matter disclosed herein, a system for presenting a transition effect between remotely-sourced content in a browser includes means for receiving an association between a transition effect and a condition for applying the transition effect when transitioning between presenting remotely-sourced content in a widget of a browser, and storing separately from the remotely-sourced content the association between the transition effect and the condition. The system further includes means for receiving, via a network, an indication to receive a second remotely-sourced content from a second content provider for presenting in the widget while a first remotely-sourced content from a first content provider is received, via the network, and presented in the widget, and means for determining whether the condition is satisfied in response to receiving the indication. The system further includes means for applying the transition effect associated with the condition to at least one of the first remotely-sourced content and the second remotely-sourced content when the condition is satisfied to create a transition that is presentable in the widget.

In another aspect of the subject matter disclosed herein, a system for presenting a transition effect between remotely-sourced content in a browser is described. The system includes a configuration access component configured for receiving and storing an association between a transition effect and a condition for applying the transition effect when transitioning between presenting remotely-sourced content in a widget of a browser, wherein the association is stored separately from the remotely-sourced content, a content manager component configured for receiving an indication to receive, via a network, a second remotely-sourced content from a second content provider while a first remotely-sourced content received from a first content provider via the network is presented in the widget, a condition monitor component configured for determining whether the condition is satisfied, and a transition engine configured for applying the transition effect associated with the condition to at least one of the first remotely-sourced content and the second remotely-sourced content when the condition is satisfied to create a transition that is presentable in the widget.

In another aspect of the subject matter disclosed herein, a computer readable medium containing a computer program, executable by a machine, for presenting a transition effect between remotely-sourced content in a browser includes instructions for receiving an association between a transition effect and a condition for applying the transition effect when transitioning between presenting remotely-sourced content in a widget of a browser, for storing separately from the remotely-sourced content the association between the transition effect and the condition, for receiving, via a network, an indication to receive a second remotely-sourced content from a second content provider for presenting in the widget while a first remotely-sourced content received from a first content provider via a network is presented in the widget, for determining whether the condition is satisfied in response to receiving the indication, and for applying the transition effect associated with the condition to at least one of the first remotely-sourced content and the second remotely-sourced content when the condition is satisfied to create a transition that is presentable in the widget.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a block diagram illustrating a system for presenting a transition effect between remotely-sourced content in a browser according to an exemplary embodiment;

FIG. 2A is a block diagram illustrating a browser in a client device according to an exemplary embodiment;

FIG. 2B is a block diagram illustrating a browser in a client device according to another exemplary embodiment;

FIG. 3 is a flowchart illustrating a method for presenting a transition effect between remotely-sourced content in a browser according to an exemplary embodiment;

FIG. 4 is an exemplary association configuration window according to an exemplary embodiment; and

FIG. 5 illustrates an exemplary display in a widget in a browser presenting a transition effect according to an exemplary embodiment.

### DETAILED DESCRIPTION

Methods, systems, and computer program products for presenting a transition effect between remotely-sourced content in a browser are disclosed. According to one embodiment, a browser in a client device is configured to receive and present remotely-sourced content from one or more content providers. The remotely-sourced content can include a web page, a video and/or audio stream, or similar content. The browser, in one embodiment, is configured to provide a transition effect between a first and a second remotely-sourced content when a specified condition is satisfied. The condition can be defined by the browser or by a user, and is associated with the transition effect. In one embodiment, the association between the transition effect and the condition is stored so that the browser can retrieve the association, determine whether the condition has been satisfied, and apply the corresponding transition effect to the first and/or second remotely-sourced content when the condition is satisfied to create a transition.

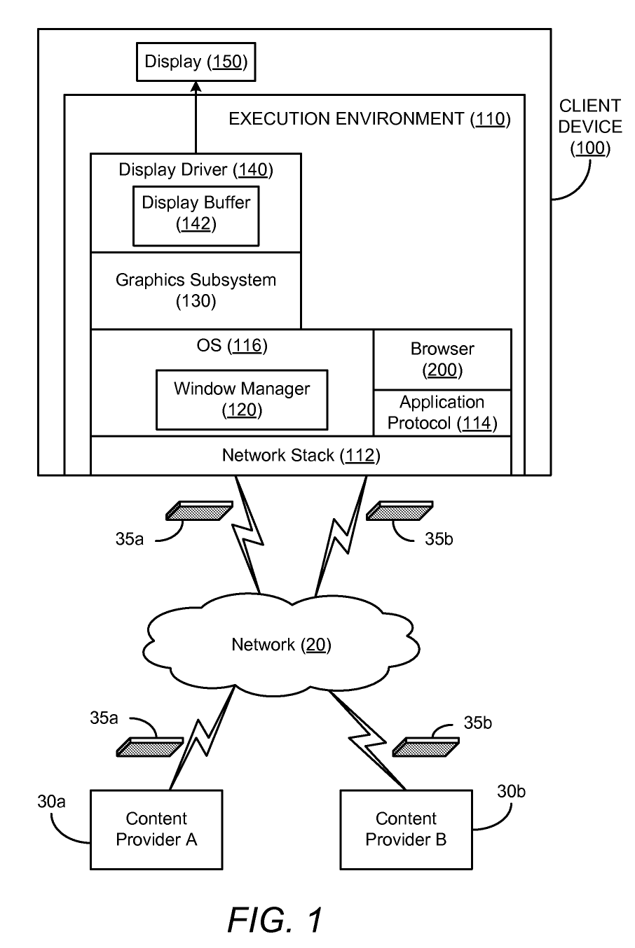

FIG. 1 is a block diagram illustrating a system for presenting a transition effect between remotely-sourced content in a browser according to one embodiment. The system 10 includes a client device 100 communicatively coupled to a plurality of content providers 30a, 30b via a network 20. The network 20 may be a Local Area Network (LAN) and/or a Wide Area Network (WAN) including the Internet, and the client device 100 can be communicatively coupled to the network 20 via a wired or wireless connection. In one embodiment, the client device 100 is configured to send requests for and/or to receive remotely-sourced content 35a, 35b from the content providers 30a, 30b over the network 20.

The client device 100, in one embodiment, includes a browser 200 for receiving remotely-sourced content 35a, 35b from the content providers 30a, 30b over the network 20 via a network stack component 112. The browser 200 can operate as an application in an execution environment 110 of the client device 100. The execution environment 110 can be any processing environment configured to support the operation of the browser 200. For example, the execution environment 110 can include an operating system (OS) 116, a processor (not shown), and various other hardware and/or software components required by the browser 200.

The client device 100 includes a display 150 included in and/or operatively coupled to the execution environment 110 of the device 100. The execution environment 110 can include a window manager 120 configured to present graphical user interface widgets. The browser 200 can invoke or otherwise interoperate with the window manager 120 to present remotely-sourced content 35a, 35b in a widget of the browser 200. The window manager 120 can invoke the drawing capabilities of a graphics subsystem 130 to draw various shapes, including text shapes, into one or more display buffers 142 managed by a display driver 140. The graphics subsystem 130 can invoke the display driver 140 to present at least a portion of the content of the display buffer(s) 142 on the display 150.

According to an exemplary embodiment, the browser 200 is configured to receive and store an association between a transition effect and a condition under which the transition effect is to be applied when presenting remotely-sourced content, e.g., web pages, in the widget. When a second web page 35b is received while a first web page 35a is being presented, the web browser 200 can determine, in one embodiment, to apply the transition effect based on whether the condition is satisfied. When the condition is satisfied, the web browser 200 can apply the transition effect to the first web page 35a and/or to the second web page 35b to create a transition between the presentation of the first 35a and second 35b web pages in the widget.

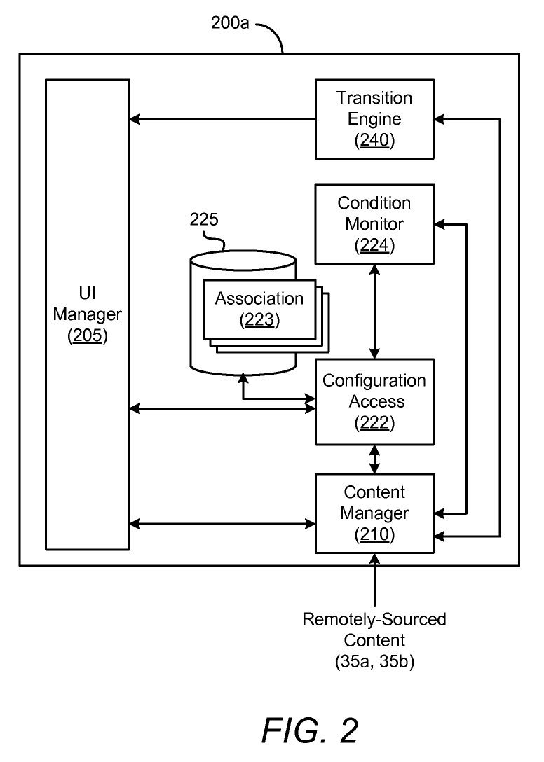

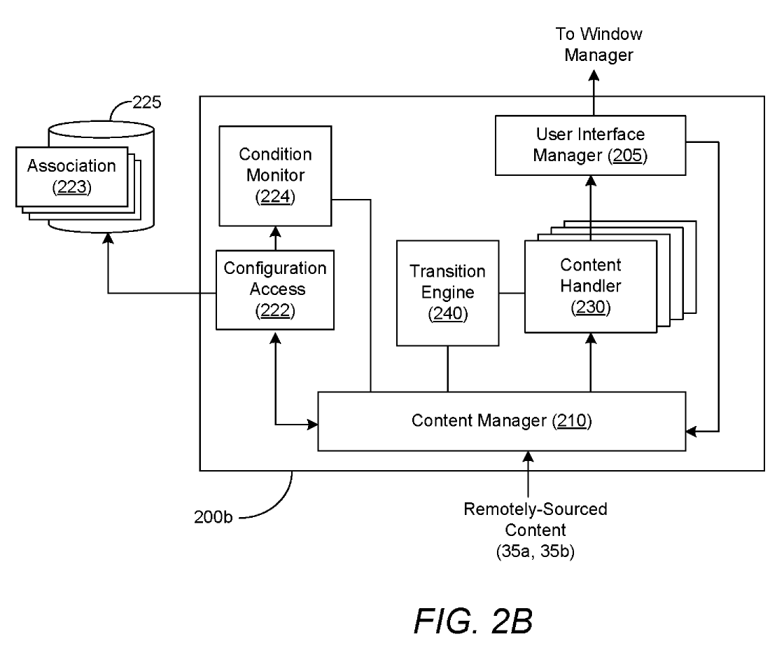

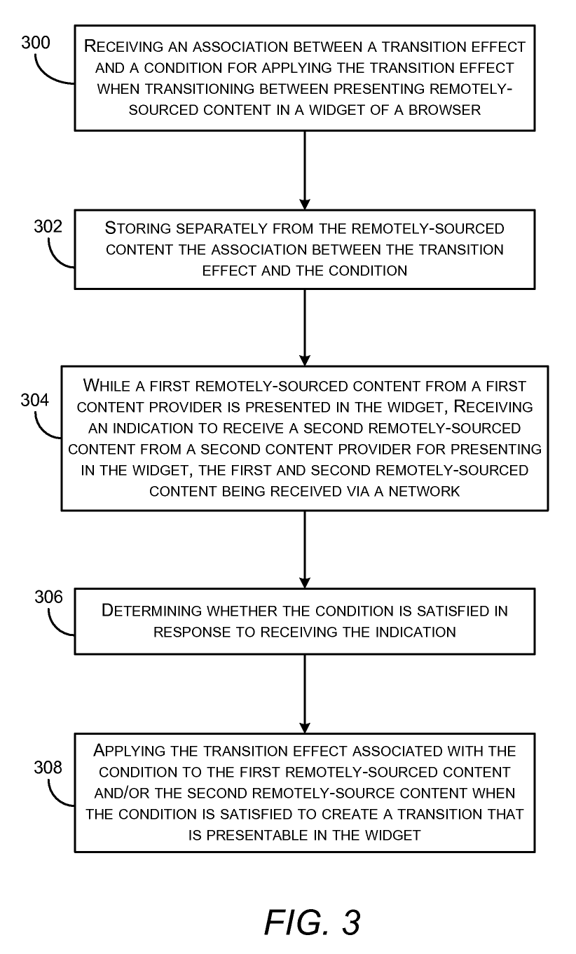

To describe with more particularity the functionality of the browser 200, reference to FIG. 2A, FIG. 2B, and FIG. 3 is made. FIG. 2A and FIG. 2B are block diagrams illustrating the browser 200 in more detail according to exemplary embodiments, and FIG. 3 is a flowchart illustrating an exemplary method for presenting a transition effect between received content in the browser 200 according to one embodiment. Referring to FIG. 1, FIG. 2A, FIG. 2B, and FIG. 3, the exemplary method begins when the browser 200 receives an association between a transition effect and a condition for applying the transition effect when transitioning between presenting remotely-sourced content in a widget of the browser (block 300). According to an exemplary embodiment, the browser 200 includes means for receiving the association between the transition effect and the condition for applying the transition effect. For example, the browser 200a, 200b can include a configuration access component 222 configured to perform this function.

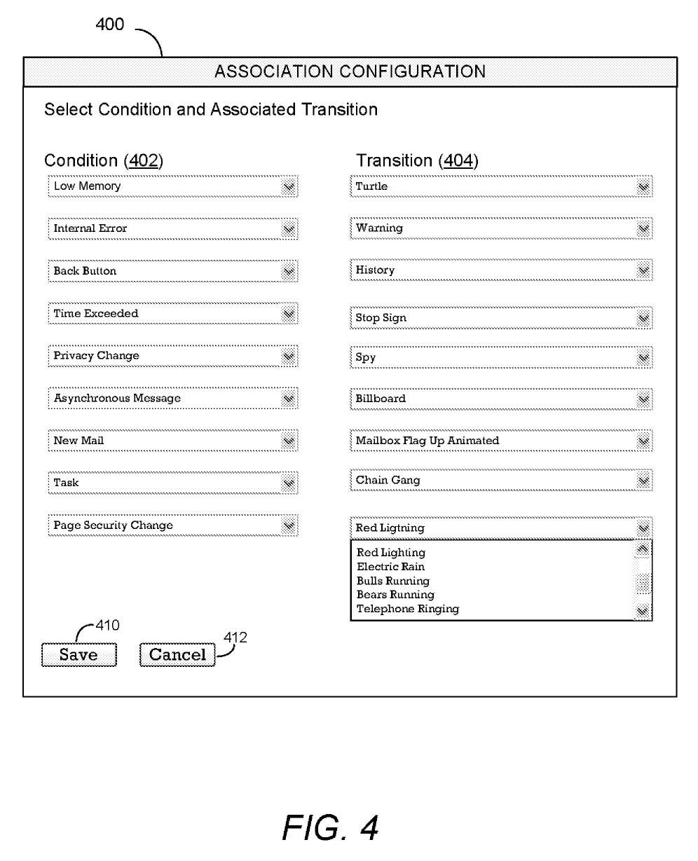

In one embodiment, the browser 200 is configured to present an association configuration dialog window for configuring the association between the transition effect and the condition. FIG. 4 illustrates an exemplary association configuration dialog window according to an exemplary embodiment. The dialog window 400 provides a plurality of selectable conditions 402 and/or a plurality of selectable transition effects 404. The plurality of conditions 402 can be based on a network domain, a security attribute, a content type, a task, a time, a user, and/or a content change associated with the first remotely-sourced content and/or the second remotely-source content. Moreover, the conditions can be related to the execution environment 110, the browser 200, and/or input conditions to the browser 200 or to another component in the device 100.

For example, execution environment 110 conditions can be based on a memory usage measure, a processor utilization threshold, and/or a logging of a message in an execution environment log. Browser conditions can be based on a specified count of open browser windows or tabs, and/or a response time threshold of an outstanding request. Content related conditions can be based on the detection of a specified content category such as news, sports, music, a security attribute of a web page or component of the page such as a video stream, and a detected type of content provider such as a retailer or a bank. Time related conditions can be based on a specified maximum time allowed for use of the browser 200, a time on a particular site, and/or a specified day, month, or time. Input related conditions can be based on input from keys, buttons, and pointing devices, as well as an input, such as a file type, identified for upload by the browser 200, an input or signal from another device such as phone, and an input from another application such as a spreadsheet or an IM client. Analogously, output conditions can also be provided. User conditions can be based on a detection of a particular user, allowing users to customize associations between conditions and transition effects. Conditions can be combined, for example, using logical operators and functional operators for creating conditional expressions. Furthermore, in one embodiment, the browser 200 can provide a predefined set of conditions, transition effects, and associations between conditions and transition effects. Other conditions can be defined, and the examples described above are illustrative and not intended to be exhaustive.

According to an exemplary embodiment, the plurality of transition effects 404 can include animated video content and/or inanimate shapes or figures. Moreover, the transition effect 404 can include an audio stream transition between a first remotely-sourced audio content and a second remotely-sourced audio content. Further, a transition effect 404 can include a transition from a first remotely-sourced video content to a second remotely-sourced audio content. Moreover, a transition effect 404 can include a transition from a first remotely-sourced content 35a having more than one content type, e.g., video and audio, to a second remotely-sourced content 35b also having more than one content type. Transitions from any type of content supported by the browser 200 to any type of content support by the browser 200, whether the types are the same or different, can be supported.

According to an exemplary embodiment, the configuration access component 222 is configured to receive an indication selecting a transition effect 404 and at least one of the plurality of conditions 402 via the dialog window 400. A user interface (UI) manager 205 of the browser can present the dialog window 400. The UI manager 205 can receive user input for receiving the indication selecting a transition effect 404 and the at least one of the plurality of conditions 402. The UI manager 205 can instruct the window manager 120 (FIG. 1) to present the dialog window 400 on the display 150 in the manner described above. Accordingly, when the “Red Lightning” transition effect 404 is selected along with the “Internal Alert” condition 404, an indication including information identifying the selected condition 402 and the selected transition effect 404 is received via the UI manager 205 via an input subsystem (not shown) in correspondence with the dialog window 400 presented on the display by the UI manager 205 via the window manager 120. The UI manager can provide information based in the received indication for creating an association 223 in a persistent data store, such as a database 225. The persistent data store can be local and/or remote, and centralized and/or distributed. Alternatively, the indication can be provided to the configuration access component 222 via the content manager component 210. Upon receiving the indication, the configuration access component 222 can pair the selected condition(s) 402 with the transition effect 404 forming the association 223 between the transition effect 404 and the condition(s) 402.

In another embodiment, associations 223 can be configured individually or in groups as allowed by the dialog window 400 where each pair of selected conditions 402 and transitions 404 can result in the creation of an association 223. For example, when all conditions 402 and associated transition effects 404 have been configured, the user can provide input for saving the condition/ transition effect pairs as an association 223 by pressing the save button component 410. The input can be received by the UI manager 205 in correspondence with the presented dialog window 400. Condition/transition effect pair information received by the UI manager 205 via the dialog window 400 can be provided to the configuration access component 222 for creating and storing associations 223 based on the received condition/transition effect pair information.

According to another embodiment, the configuration access component 222 can be configured to receive or access a configuration file that includes the association 223, and to import the association 223 from the configuration file. In this embodiment, the configuration file can be identified using a naming convention or identified through received user input provided by the UI manager 205 to the configuration access component 222 component. In other embodiments, an association 223 between a transition effect and a condition can be received or created in response to information received over the network 20 via the network stack 112. The information can be received from a protocol layer of the network stack 112 and/or via an application protocol 114, such as Hypertext Transfer Protocol (HTTP), interoperating with the network stack 112.

In one embodiment, association information can be identified by a MIME type and received over the network 20 by the content manager component 210, which recognizes the MIME type that corresponds to the association information. The content manager component 210 can be configured to route the received association information to the configuration access component 222 based on the MIME type.

Referring again to FIG. 3, when the association 223 between the transition effect and the condition is received, the association 223 is stored separately from the remotely-sourced content (block 302). According to an exemplary embodiment, the browser 200 includes means for storing separately from the remotely-sourced content the association 223 between the transition effect and the condition. For example, the configuration access component 222 can be configured to perform this function. In one embodiment, the associations 223 can be stored in a data store 225 managed by the browser 200, and shared with other executables. In another embodiment, the associations 223 can be stored in a local data store 225 of the device 100 and/or in a remote data store (not shown) separately from the content providers 30a, 30b.

According to an exemplary embodiment, the browser 200 can receive and present a first remotely-sourced content 35a from a first content provider 30a. For example, in one embodiment, the content manager component 210 can be configured to receive the first remotely sourced content 35a, such as a video stream, from the first content provider 30a, and to cause the UI manager 205 of the browser 200 to present in one or more widgets the first remotely-sourced content 35a based on the content type(s) included in the first remotely-sourced content 35a.

In one embodiment, the browser 200b can include a plurality of content handler components 230 configured to process content based on a content type, e.g., MIME type, of the content. For example, an audio/* content handler 230 can be configured for processing audio content types, an XMPP-IM content handler component 230 can be configured to handle content formatted according to an XMPP-IM schema for processing instant messages (IM) and presence, and an HTML content handler component 230 can be configured for processing one or more variants of HTML content. Each content handler component 230 is configured to interoperate with the UI manager 205 for presenting the content of a corresponding content type.

According to an exemplary embodiment, the content manager component 210 can determine the content type of the first remotely sourced content 35a and identify a content handler component 230 configured to process the content based on its determined content type. For example, when the first remotely-sourced content 35a is a video stream, the content manager component 210 can invoke a video/* content handler component 230. The content handler component 230, in one embodiment, can call the UI manager 205 and provide a representation of at least a portion of the first remotely-sourced content 35a for presentation on the display 150 in a widget supported by the window manager 120 in the manner described above.

Referring again to FIG. 3, while the first remotely-sourced content 35a from the first content provider 30a is presented in the widget, the exemplary method continues when an indication to receive a second remotely-sourced content 35b from a second content provider 30b for presenting in the widget is received (block 304). In one embodiment, the first 35a and second 35b remotely-sourced content is received via the network 20. The browser 200 includes means for receiving the indication to receive the second remotely-sourced content 35b from the second content provider 30b for presenting in the widget while the first remotely-sourced content 35a from the first content provider 30a is presented in the widget. For example, the content manager component 210 in the browser 200a, 200b can be configured to perform this function.

While the first remotely-sourced content 35a is presented in the widget, the content manager component 210 can receive the indication to receive the second remotely-sourced content 35b via, for example, the UI manager 205 or via a content handler 230 interoperating with the UI manager 205. For example, the indication can be associated with a selectable link included in the first remotely-sourced content 35a by a content handler 230 associated with the content including the link or with a URL submitted via a location bar widget (not shown) by the UI manager 205. In one embodiment, the indication can identify the second content provider 30b and/or the second remotely-sourced content 35b to be received from the identified second content provider 30b.

In response to receiving the indication, the content manager component 210 can receive the second remotely-sourced content 35b via a synchronous and/or an asynchronous message. For instance, in one embodiment, the content manager component 210 can send a request message to the second content provider 30b that includes a request to receive the second remotely-sourced content 35b over the network 20 via the network stack 112. Alternatively, or in addition, the content manager component 210 can receive the indication as an asynchronous message from the second content provider 30b, e.g., pursuant to a subscription. In this embodiment, the indication itself can include the second remotely-sourced content 35b.

In response to receiving the indication to receive the second remotely-sourced content 35b or in response to receiving the second remotely sourced content 35b, the browser 200 is configured to determine whether the condition is satisfied (block 306). According to one embodiment, the browser 200 includes means for determining whether the condition is satisfied in response to receiving the indication. For example, the browser 200a, 200b can include a condition monitor component 224 configured for performing this function.

According to an exemplary embodiment, the content manager component 210 can notify or call the condition monitor component 224 for determining whether a condition specified in an association 223 is satisfied or matched. For certain conditions, the condition monitor component 224 can actively monitor information from the browser 200a, 200b, an application, and/or an external source to determine whether the condition is satisfied based on the monitored information. For example, the condition monitor component 224 can poll the browser 200a, 200b, the execution environment 110, and/or the external source for information associated with evaluating a condition.

Alternatively, or in addition, the condition monitor component 224 can monitor a particular condition based on receiving an asynchronous notification that is unsolicited and/or based on a subscription. For example, the condition monitor component 224 can subscribe to receive notifications of events logged in an execution environment event log (not shown). In another embodiment, the condition monitor component 224 can be configured to set timers related to certain conditions and to associate a handler portion of the condition monitor 224 with a particular time related event in response to receiving the indication.

When the condition is satisfied, the transition effect 404 associated with the satisfied condition is applied to at least one of the first remotely-sourced content 35a and the second remotely-sourced content 35b to create a transition that is presented in the widget (block 308). According to one embodiment, the browser 200 includes means for applying the transition effect 404 associated with the condition to the first remotely-sourced content 35a and/or the second remotely-sourced content 35b. For example, a transition engine 240 can be configured to perform this function.

When the condition monitor component 224 determines a condition is satisfied, according to an exemplary embodiment, the condition monitor component 224 determines the transition effect 404 specified in the association 223 corresponding to the satisfied condition. The condition monitor component 224 can then provide transition effect information associated with the specified transition effect 404 to the content manager 210. The content manager component 210 can be configured for determining one or more content handlers 230 for providing for applying and presenting at least a portion of the specified transition effect 404. The content handler components 230 can be determined by the content handler component 210 based on information including the transition effect information, a content type of the first remotely-source content 35a, and a content type of the second remotely sourced content 35b.

For example if a security attribute associated with first remotely-source content and the second remotely source content changes, the condition monitor 224 can be configured to detect the change.. The condition monitor component 224 can locate an association 223 matching the condition of a security attribute change and provide the transition effect information associated with the transition effect 404 to the content manager component 210 as just described. The content manager component 210 can invoke a content handler 230 matching a MIME type of the transition effect 404, e.g., a “Red Lightning” transition, included in the matching association 223.

According to one embodiment, the content handler component 230 can invoke the transition engine 240 for generating at least a portion of the transition effect 404, e.g., the “Red Lightning” transition. The transition engine 240 can be specific to the content handler component 230 or can be a transition engine 240 shared by a plurality of content handlers 230. The content handler component 230 interoperating with the transition engine 240 can apply the transition effect 404 to the first remotely source content 35a and/or to the second remotely source content 35b to generate a transition that is presentable in the widget presenting the first remotely-sourced content 35a and second remotely-sourced content.

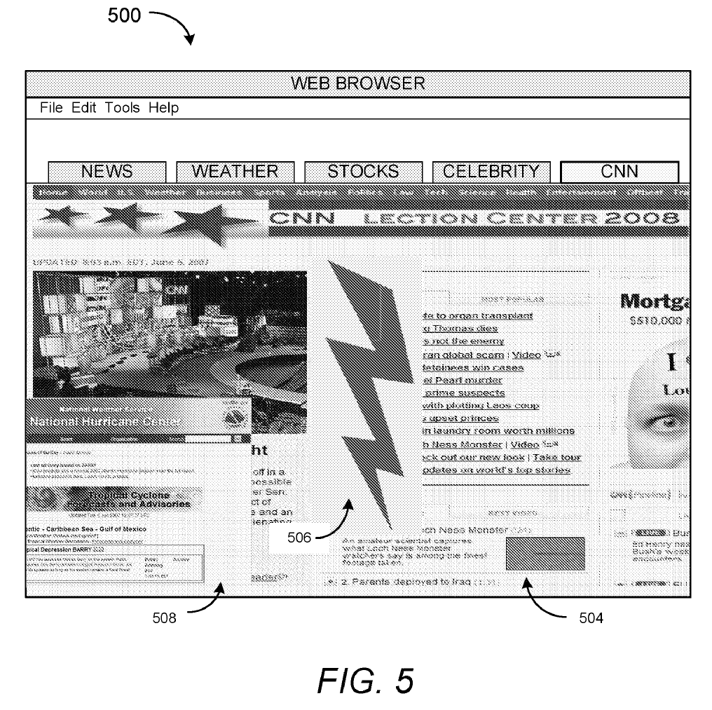

For example, suppose the first 35a and second 35b remotely-sourced content are first and second HTML pages, respectively, and the transition effect 404 is the “Red Lightning” transition. In this example, the content manager component 210 can invoke a video/* content handler component 230, which instructs the transition engine 240 to begin assembling a transition sequence as indicated by the transition effect information provided by the content manager component 210 while the first HTML page 35a is presented. The transition sequence, in one embodiment, can include a presentation of a first sequence of video frames including the first HTML page, followed by a video stream rendered using a combination of the first HTML page, the transition effect 404, and the second HTML page, followed by a last sequence of video frames presenting the second HTML page in its normal format. FIG. 5 shows an exemplary display of a browser transitioning from a first remotely-sourced content 504, e.g., content sourced by www.cnn.com, to a second remotely-sourced content 508, e.g., content sourced by the National Hurricane Center, using the “Red Lightning” transition effect 506 based on a detected change in a security attribute between the content sourced by www.cnn.com and the content sourced by the National Hurricane Center.

In another embodiment, while first remotely-sourced content 35a can be an HTML page, the second remotely-source content 35b can be a three dimensional VRML page. In this instance, the content manager component 210 can invoke a content handler component 230, which directs a transition engine 240 to build a transition sequence that includes video frames including content from the HTML page 35a, followed by a video stream rendered using a combination of the HTML page 35a, the transition effect, and the VRML content 35b, followed by video frames presenting the VRML content in its normal format. In one embodiment, the portions of the transition sequence including the VRML content 35b can have spatial qualities so that the transition sequence is seamless.

In another example, the first 35a and second 35b remotely-sourced content can be video streams and the condition detected can be associated with a time limit a current user is allowed to use the browser 200a, 200b. The matching of the condition can be determined via a timer set by the condition monitor component 224 when the browser 200a, 200b detects initial browsing activity by an identified user. A transition effect 404 associated with the timer related condition 402 can be a fade effect where a hexagon pattern corresponding to a stop sign is presented between transitions from a pixel in a frame from the first video stream 35a to a pixel in a frame from the second video stream 35b. The transition effect 404 can indicate to a user that the browser 200a, 200b will stop operating in a specified period of time, e.g., five minutes.

The transition engine 240, in one embodiment, can be configured to generate the transition using content from at least one of the first remotely-sourced content 35a and the second remotely-sourced content 35b until the transition effect 404 is complete. In this manner, the presentation of the transition sequence can provide a smooth segue from the first remotely-sourced content 35a to the second remotely-sourced content 35b while the second remotely-sourced content 35b is loading and being rendered. When content from the first content provider 30a is no longer needed, the transition engine 240 can indicate to the content manager component 210 that communication with the first content provider 30a can be terminated.

As an alternative, or in addition, to video based transitions, a transition effect 404 can be generated by a transition engine 240 interoperating with a content handler 230 by drawing to one or more display buffers (not shown) using a graphics subsystem (not shown) of the execution environment described analogous to the execution environment 110 described above.

Through aspects of the embodiments described, a browser 200 is configured to provide a transition effect between a first 35a and a second 35b remotely-sourced content when a specified condition is satisfied. In one embodiment, a user can define the transition effects 404 and the conditions 402 under which the transitions are applied to the remotely-sourced content. Associations 223 between conditions 402 and transition effects 404 are stored for use by the browser 200. When a specified condition is satisfied, the corresponding transition effect can be applied to the first and/or second remotely-sourced content and presented prior to the presentation of the second remotely-sourced content, thereby creating a visually appealing transition from the first content 35a to the second content 35b.

It should be understood that the various components illustrated in the figures represent logical components that are configured to perform the functionality described herein and may be implemented in software, hardware, or a combination of the two. Moreover, some or all of these logical components may be combined and some may be omitted altogether while still achieving the functionality described herein.

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any medium that can contain, store, communicate, propagate, or transport instructions for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, a portable compact disc read-only memory (CDROM), a portable digital video disc (DVD), a wired network connection and associated transmission medium, such as an ETHERNET transmission system, and/or a wireless network connection and associated transmission medium, such as an IEEE 802.11(a), (b), or (g) or a BLUETOOTH transmission system, a wide-area network (WAN), a local-area network (LAN), the Internet, and/or an intranet.

Thus, the subject matter described herein can be embodied in many different forms, and all such forms are contemplated to be within the scope of what is claimed.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for presenting a transition effect between remotely-sourced content in a browser, the method comprising:
receiving an association between a transition effect and a condition for applying the transition effect when transitioning between presenting remotely-sourced content in a widget of a browser;
storing separately from the remotely-sourced content the association between the transition effect and the condition;
while a first remotely-sourced content from a first content provider is presented in the widget, receiving an indication to receive a second remotely-sourced content from a second content provider for presenting in the widget, the first and second remotely-sourced content being received via a network;
determining whether the condition is satisfied in response to receiving the indication; and
applying the transition effect associated with the condition to at least one of the first remotely-sourced content and the second remotely-sourced content when the condition is satisfied to create a transition that is presentable in the widget.

2. The method of claim 1 further comprising configuring the association, wherein configuring the association includes:
presenting a dialog window component that provides at least one of a plurality of selectable conditions and a plurality of selectable transition effects;
receiving an indication selecting at least one of the plurality of conditions and a transition effect; and
pairing the selected at least one conditions with the transition effect such that the condition/transition effect pair form an association.

3. The method of claim 1 wherein receiving the association includes:
receiving a configuration file that includes the association; and
importing the association from the configuration file.

4. The method of claim 1 wherein the condition is based on at least one of a network domain, a security attribute, a content type, a task, a time, a user, and a content change associated with at least one of the first remotely-source content and the second remotely-sourced content.

5. The method of claim 1 wherein determining whether the condition is satisfied includes monitoring information from at least one of a browser, an application, and an external source.

6. The method of claim 1 wherein determining whether the condition is satisfied includes monitoring a particular condition based on receiving an asynchronous notification.

7. The method of claim 1 wherein the second remotely-sourced content is received via at least one of a synchronous message and an asynchronous message.

8. The method of claim 1 wherein applying the transition effect includes: receiving transition effect information associated with the transition effect corresponding to the satisfied condition; and
providing for presenting at least a portion of the transition effect based on at least one of a content type of the first remotely-sourced content, a content type of the second remotely-sourced content, and the received transition effect information.

9. A system for presenting a transition effect between remotely-sourced content in a browser, the system including:
means for receiving and storing an association between a transition effect and a condition for applying the transition effect when transitioning between presenting remotely-sourced content in a widget of a browser, wherein the association is stored separately from the remotely-sourced content;
means for receiving an indication to receive a second remotely-sourced content from a second content provider while a first remotely-sourced content from a first content provider is presented in the widget, the first and second remotely-sourced content being received via a network;
means for determining whether the condition is satisfied in response to receiving the indication; and
means for applying the transition effect associated with the condition to at least one of the first remotely-sourced content and the second remotely-sourced content when the condition is satisfied to create a transition that is presentable in the widget.

10. A browser for presenting a transition effect between remotely-sourced content in a browser, the browser including:
a configuration access component configured for receiving and storing an association between a transition effect and a condition for applying the transition effect when transitioning between presenting remotely-sourced content in a widget of a browser, wherein the association is stored separately from the remotely-sourced content;
a content manager component configured for receiving an indication to receive, via a network, a second remotely-sourced content from a second content provider while a first remotely-sourced content received from a first content provider via the network is presented in the widget;
a condition monitor component configured for determining whether the condition is satisfied; and
a transition engine configured for applying the transition effect associated with the condition to at least one of the first remotely-sourced content and the second remotely-sourced content when the condition is satisfied to create a transition that is presentable in the widget.

11. The browser of claim 10 wherein the configuration access component interoperating with a user interface manager is configured for presenting a dialog window component that provides at least one of a plurality of selectable conditions and a plurality of selectable transition effects, for receiving an indication selecting at least one of the plurality of conditions and a transition effect, and for pairing the selected at least one conditions with the transition effect such that the condition/transition effect pair form an association.

12. The browser of claim 10 wherein the configuration access component is configured for receiving a configuration file that includes the association, and for importing the association from the configuration file.

13. The browser of claim 10 wherein the condition is based on at least one of a network domain, a security attribute, a content type, a task, a time, a user, and a content change associated with at least one of the first remotely-source content and the second remotely-sourced content.

14. The browser of claim 10 further comprising:
a plurality of content handler components configured for processing content based on content type, wherein the content manager component is configured for receiving, via the network, association information including the condition and the transition effect, wherein the association information is identified by a content type, and configured for identifying one of the plurality of content handler components based on the content type, the identified content handler component configured for processing the association information based on the content type.

15. The browser of claim 10 wherein the condition monitor component is configured for monitoring information from at least one of a browser, an application, and an external source to determine whether the condition is satisfied.

16. The browser of claim 10 further comprising:
a plurality of content handler components configured for processing content based on content type, wherein the content manager component is configured for selecting a content handler component based on the content type of at least one of the first remotely-sourced content and the second remotely-sourced content, wherein the selected content handler component is configured for providing for applying and presenting at least a portion of the transition effect.

17. The browser of claim 10 wherein the second remotely-sourced content is received via at least one of a synchronous message and an asynchronous message.

18. The browser of claim 10 further comprising:
a plurality of content handler components coupled to a transition engine and configured for processing content based on content type, wherein the content manager component is configured for receiving the transition effect associated with the satisfied condition via the condition monitor component, and for determining a content handler component of the plurality of content handler components configured for providing for presenting at least a portion of the transition based on at least one of a content type of the first remotely-sourced content, a content type of the second remotely-sourced content and the transition effect.

19. A computer readable medium containing a computer program, executable by a machine, for presenting a transition between remotely-sourced content in a browser, the computer program comprising executable instructions for:
receiving an association between a transition effect and a condition for applying the transition effect when transitioning between presenting remotely-sourced content in a widget of a browser;
storing separately from the remotely-sourced content the association between the transition effect and the condition;
while a first remotely-sourced content from a first content provider is presented in the widget, receiving an indication to receive a second remotely-sourced content from a second content provider for presenting in the widget, the first and second remotely-sourced content being received via a network;
determining whether the condition is satisfied in response to receiving the indication; and
applying the transition effect associated with the condition to at least one of the first remotely-sourced content and the second remotely-sourced content when the condition is satisfied to create a transition that is presentable in the widget.
